(19) United States
(12) Patent Application Publication
(10) Pub. No.: US 2006/0010303 A1
(43) Pub. Date: Jan. 12, 2006

(54) Technique and system for allocating and managing memory

(76) Inventors: Gansha Wu, Beijing (CN); Guei-Yuan Lueh, San Jose, CA (US); Jesse Z. Fang, San Jose, CA (US)

Correspondence Address: TROP PRUNER & HU, PC, 8554 KATY FREEWAY, SUITE 100, HOUSTON, TX, 77024, US

(21) Appl. No.: 10/889,372

(22) Filed: Jul. 12, 2004

(51) Int. Cl. G06F 12/00

(52) U.S. Cl. 711/170

(57) ABSTRACT

In an embodiment of the invention, a technique includes assigning a first pointer to an address of an array and using the first pointer to identify a first location of first data of the array. The first pointer is used to locate at least one additional pointer to identify at least one additional location of additional data of the array.

### BACKGROUND

The invention generally relates to a technique and system for managing memory.

Managed runtime environments (a JAVA® environment, for example) are prevalent on emerging mobile or embedded systems that have constrained memories. A small memory poses challenges on automatic memory management. Among those challenges are challenges relating to allocating and managing memory for a data structure called an array. Furthermore, challenges may exist in that when allocating memory for a particular array, the memory available for allocation may be fragmented. In other words, the array may need a specific amount of memory. However, the available segments of memory may be smaller than this specific amount. Thus, the allocated memory for the array may not be located in a contiguous range of memory addresses, but rather, the allocated memory may span across several non-contiguous memory locations. In a conventional system, such a fragmented allocation may possibly introduce larger access times to the array.

Thus, there is a continuing need for better ways to manage memory in a system that has a small memory space.

### BRIEF DESCRIPTION OF THE DRAWING

FIG. 1 is a block diagram of a virtual machine according to an embodiment of the invention.

FIG. 2 is a schematic diagram of a system illustrating the allocation of memory for an array according to an embodiment of the invention.

FIG. 3 is a schematic diagram illustrating an access to memory of an array according to an embodiment of the invention.

FIG. 4 is an illustration of the format of a contiguous array according to an embodiment of the invention.

FIG. 5 is an illustration of the format of a discrete array according to an embodiment of the invention.

FIG. 6 is a flow diagram depicting a technique to allocate memory for an array according to an embodiment of the invention.

FIG. 7 is a flow diagram depicting a technique to access memory of an array according to an embodiment of the invention.

FIGS. 8 and 9 are flow diagrams depicting different techniques to reallocate memory for the array in response to garbage collection cycles according to different embodiments of the invention.

FIG. 10 is a schematic diagram of a wireless device according to an embodiment of the invention.

### DETAILED DESCRIPTION

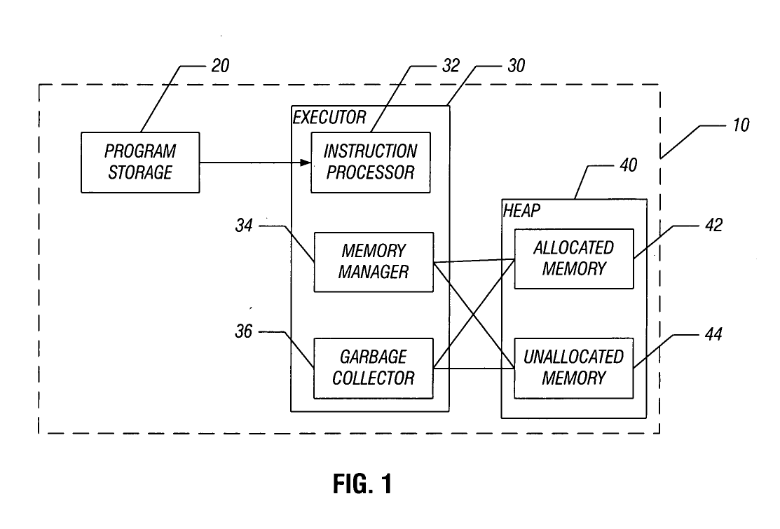

Referring to FIG. 1, an embodiment 10 of a virtual machine (a JAVA® virtual machine, for example) in accordance with the invention includes program storage 20, an executor 30 and a memory heap 40. The program storage 20 stores program instructions (JAVA® bytecode, for example) that are executed by an instruction processor 32 (interpreters or Just-In-Time compilers, for example) of the executor 30. In the course of operation, the instructions that are executed by the instruction processor 32 may request the creation of an array. For purposes of allocating memory for the array and accessing the array, the executor 30 includes a memory manager 34.

The memory manager 34, as further described below, searches an unallocated memory region 44 of the heap 40 for purposes of locating memory for the array. As further described below, the memory segments in the unallocated memory region 44 may be fragmented, or “discretized,” in that the memory may not be formed from a single segment of contiguous memory locations, but rather, the unallocated memory region 44 may be discretized into several segments that are in non-contiguous memory addresses. The memory that is allocated by the memory manager 34 for the array forms a region 42 of the heap 40 called the allocated memory. For the same reasons set forth above, the allocated memory region 42 may be fragmented, or discretized.

The executor 30 also includes a garbage collector 36. The function of the garbage collector 36 is to free up previously-allocated memory of the heap 40 that is not currently being used. More specifically, in some execution environments, such as a JAVA® virtual machine, for example, objects are not required to free up allocated memory after the object is through using the allocated memory. Thus, the garbage collector 36 regularly scans the heap 40 for purposes of freeing up previously allocated memory and increasing the size of the unallocated memory region 44.

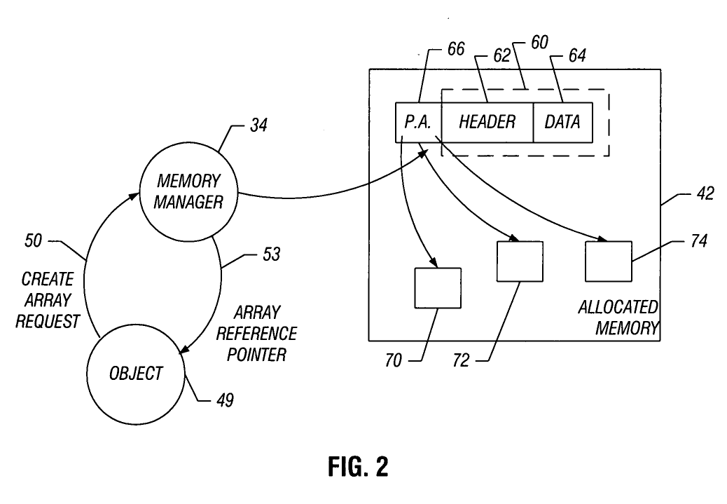

Referring to FIG. 2, in accordance with some embodiments of the invention, the memory manager 34 allocates memory for an array in the following manner. The creation of the array occurs in response to a request (at 50) from an allocation site 49 to create an array. In response to this request, the memory manager 34 creates an array reference 60, a “visible” part of the array from the allocation site's perspective. More specifically, in some embodiments of the invention, the array reference 60 includes a header field 62 and a data region 64, herein called the “part one data region 64.” The memory manager 34 passes (at 53) a reference pointer to the allocation site 49 identifying the location of the array reference 60. As further described below, the header 62 contains information identifying the array type and other information (described below) that indicates the organization of the array.

The unallocated memory region 44 of the heap 40 (FIG. 1) may be significantly fragmented, which means that no single contiguous segment, of the memory may be large enough to accommodate the array. Thus, for such a scenario, the memory manager 34 cannot form a “contiguous array,” an array whose allocated memory spans across contiguous memory locations. Therefore, the memory manager 34 allocates memory for the array using several fragments that are not part of the same contiguous memory space. In other words, the memory manager creates a “discrete array,” an array whose allocated memory spans across two or more non-contiguous memory locations.

In some embodiments of the invention, the allocation site 49 is unaware (i.e., does not “see”) whether the array is a contiguous array or a discrete array. Rather, the allocation site 49 views the array reference 60 as containing the header 61 and the part one data region 64. For the case in which the array is a discrete array, the part one data region 64 contains the first part of but not all of the data for the array. Rather, the memory manager 34 allocates additional memory segments, called “tailing parts,” for the remainder of the array. For example, FIG. 2 depicts exemplary tailing parts 70, 72 and 74 that, in combination with the part one data region 64, form the allocated memory for a particular array. The tailing parts 70, 72 and 74 are located in non-contiguous memory locations relative to the part one data region 64 and relative to each other.

The memory manager 34 creates region 66 for the discrete array reference, called a pointer region 66, in a known location relative to the location of the array reference 60. However, the pointer region, in some embodiments of the invention, is invisible to the allocation site 49. As an example, in some embodiments of the invention, the region 66 may be located in the same contiguous memory space as the array reference 60. As a more specific example, the pointer region may be located in a memory location that directly proceeds or precedes the address of the array reference pointer, depending on the particular embodiment of the invention. In some embodiments of the invention, although the pointer region 66 is invisible to the allocation site 49, the memory manager 34 uses information in the region 66 to access array data that is not located in the part one data region 64.

More specifically, in some embodiments of the invention, the pointer region 66 stores pointers to the tailing parts. Thus, the memory manager 34 uses the pointers to locate the addresses of the data elements of the array whose indexes are greater than the length of the part one data region 64.

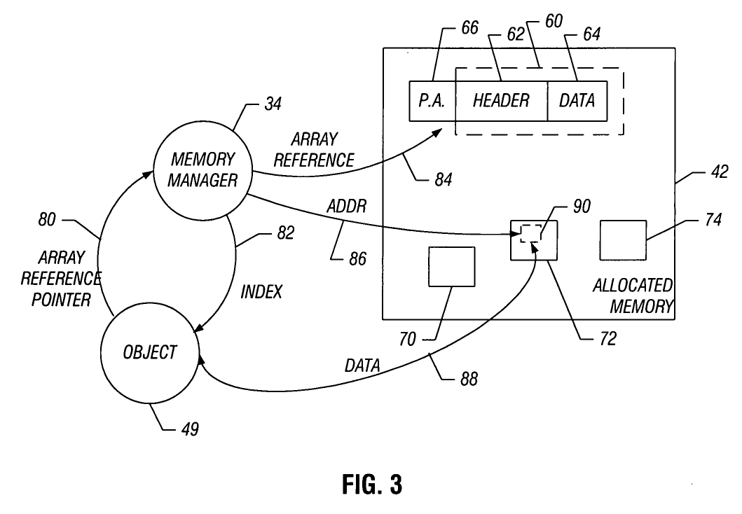

As a more specific example, referring to FIG. 3, the allocation site 49 provides an array reference pointer (at 80) and an index (at 82) for purposes of accessing the created array. In response to these parameters, the memory manager 34 accesses the array reference 60. If the index provided by the allocation site 49 references data that is not contained in the part one data region 64, then the memory manager 34 uses the index to point to the appropriate pointer in the pointer region 66 to determine the address of the targeted array element.

For example, if the index that is provided by the allocation site 49 targets an array element that is contained in the part one data region 64, then the memory manager 34 computes an address that identifies the appropriate location in the part one data region 64 so that the allocation site 49 may access this location. However, as depicted in FIG. 3, if the index provided by the allocation site 49 targets an array element that is not in the part one data region 64, then the memory manager 34 uses the pointer region 66 (as further described herein) to derive the address for the targeted element. In this manner, the memory manager 34 provides the appropriate address (at 86) to access the appropriate location 90. For the example that is depicted in FIG. 3, this location 90 resides in the memory segment 72.

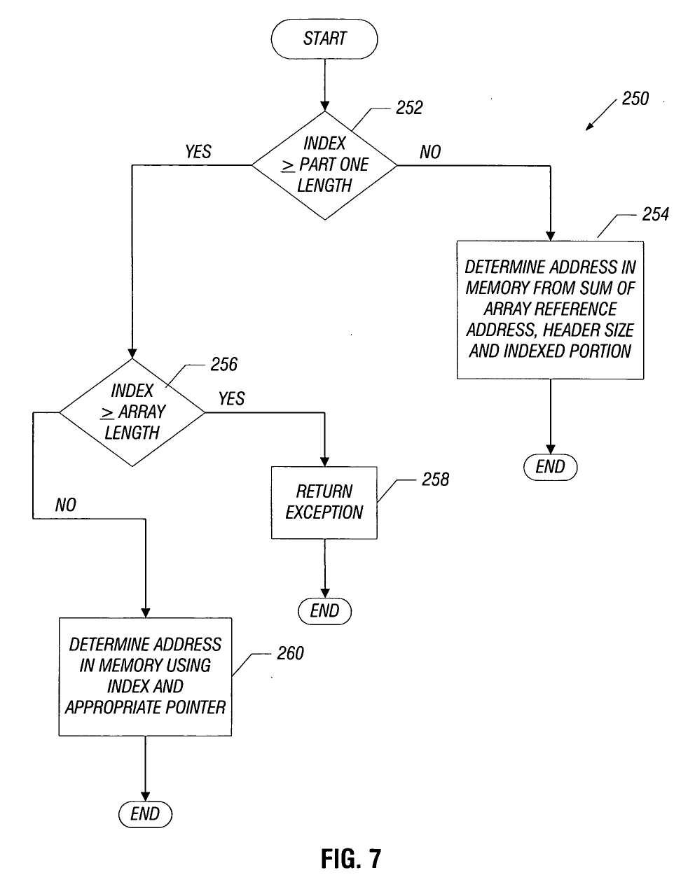

In some embodiments of the invention, the memory manager 34 allocates memory for an array by attempting to place as much of the data as possible in the part one data region 64. In other words, the memory manager 34, in some embodiments of the invention, attempts to maximize the size of the part one data region 64 relative to the other available allocated memory segments. Thus, if a large enough memory segment is available, the entire array may be located in contiguous memory, i.e., in the part one data region 64. However, even if the largest segment does not accommodate the entire array, the memory manager 34 still allocates the largest memory segment to the part one data region 64 and allocates memory for the remainder of array in the tailing parts. A significant feature of this design is to let as many array accesses as possible occur in the part one region 64. According to an array access algorithm (described below in connection with FIG. 7), the access to part one region is as efficient as the access to a contiguous array. For an embodiment targeting for high performance, the tailing parts are preferred to being equally sized, so that access to tailing parts can still be within some time bounds.

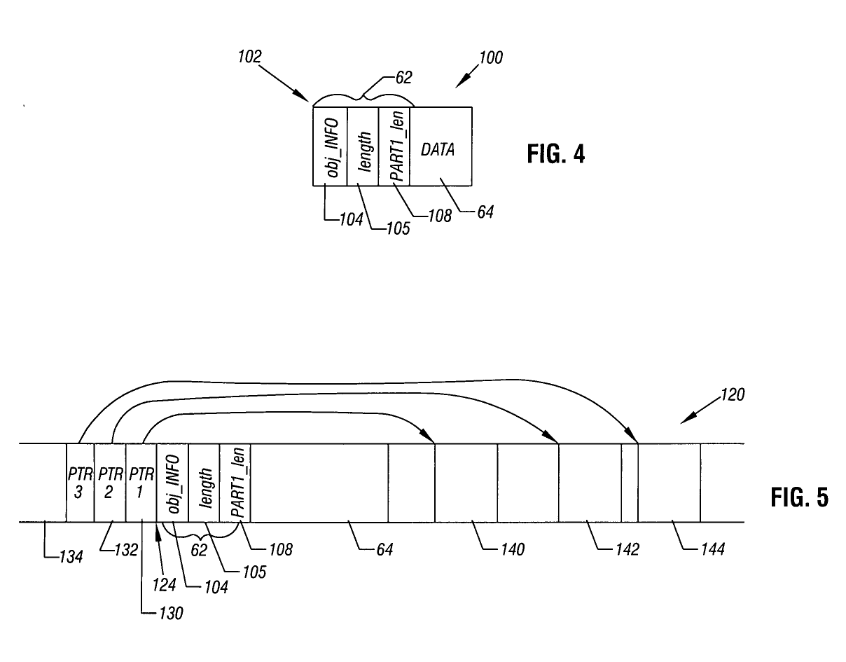

Referring to FIG. 4, in some embodiments of the invention, the array reference 60 may have a format 100 when the array is located entirely in contiguous memory space (i.e., a memory region formed from a contiguous range of memory addresses). As shown, the header field 62 includes an object information field 104 that identifies the allocation site 49; and the header field 62 also includes fields 105 and 108 that identify whether the array is a discrete array or a contiguous array. More specifically, in some embodiments of the invention, the field 105 indicates the length of the data for the entire array. For cases in which the part one data field 64 constitutes the entire data for the entire array (such as the case for the array format 100), the length of the data for the array is the same as the length of the part one data region 64. The field 108 indicates the length (in terms of number of array elements) of the part one data region 64. Thus, for a contiguous array, the lengths indicated by the fields 105 and 108 are identical. Thus, the memory manager 34, by comparing the values in the fields 105 and 108, may determine whether the pointer region 66 needs to be accessed. For the case of the contiguous array 100, no pointer region 66 exists, as there are no tailing parts in the memory that is allocated for the array.

FIG. 5 depicts a format 120 for a discrete array. The format 120 is similar to the format 100, in that the format 120 includes a header field 62, that, in turn, includes the object information field 104, the length field 105, and the part one data length field 108. However, for the discrete array format 120, the length indicated by the field 105 is greater than the length indicated by the field 108, as tailing parts exist in the memory that is allocated for array. Thus, for the discrete array format 120, the memory manager 34 builds and accesses a pointer field 62 which, for this example, includes fields 130, 132 and 134 that are directed to three different pointers and thus, three different tailing parts 140, 142 and 144, respectively.

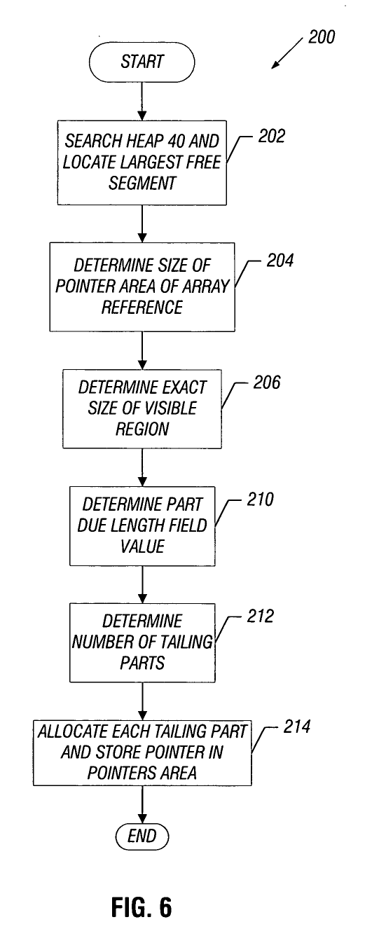

Referring to FIG. 6, as a more specific example, the memory manager 34 may use a technique 200 for purposes of allocating memory for an array, in accordance with some embodiments of the invention. Pursuant to the technique 200, the memory manager 34 searches the heap 40 and locates the largest free memory segment, as depicted in block 202. Next, the memory manager 34 determines (block 204) the size of the pointer region 66 and determines (block 206) the size of the region of the array reference that is visible to the allocation site 49. Thus, in blocks 204 and 206, the memory manager 34 determines the sizes of the header 62 and pointer 66 regions. This data occupies some of the free segment that was found by the memory manager 39 in block 202. Therefore, from this information, the memory manager 34 determines (block 210) the length of the part one data region 64. Subsequently, the memory manager 39 determines (block 212) the number of tailing parts and then allocates each tailing part and stores a pointer in the pointer region 66 for each tailing part, as depicted in block 214.

Referring to FIG. 7, in some embodiments of the invention, the memory manager 34 may use a technique 250 for purposes of generating the address to access a particular element of an array. The allocation site 49 provides the memory manager 34 with the array reference pointer, as well as an index to the targeted array location. Pursuant to the technique 250, the memory manager 34 determines (diamond 252) whether the index is greater than the length of the part one data region 64. If not, then the memory manager 34 computes the address, as the targeted location is located in the part one data region. This process is as efficient as the access to a contiguous array. In this manner, the memory manager 34 determines (block 254) the address in the heap memory from the sum of the array reference address, the header size and the value indicated by the index.

If the index is greater than or equal to the length of the part one data region 64, then the memory manager 34 determines (diamond 256) whether the index is greater than or equal to the total array length. If so, then the allocation site 49 has made an array access request that is beyond the bounds of the array, and as such, the memory manager 34 returns (block 258) an exception to the allocation site 49. If in diamond 256 the memory manager 34 determines that the index less than the total array length, then the memory manager 34 determines the address in the heap memory using the index and the appropriate pointer from the pointer region 66, as depicted in block 260.

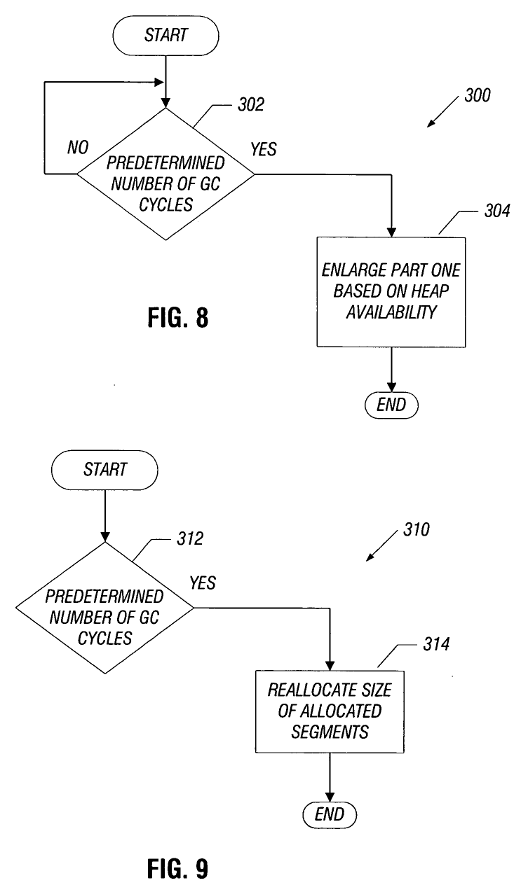

Referring to FIG. 8, in some embodiments of the invention, the memory manager 34 may change the layout of a particular array after a predetermined number of garbage collection cycles. For example, FIG. 8 depicts a technique 300 that may be used by the memory manager 34 for purposes of more efficiently allocating the array. Pursuant to the technique 200, the memory manager 34 determines (diamond 302) whether a predetermined number of garbage collection cycles have occurred. In many other embodiments, the memory manager 34 makes this decision not by a fixed number of GC occurrences, but uses more flexible heuristics, e.g., the status of heap fragmentation, performance degradation due to frequent access to some specific region, e.g., tailing parts, of a discrete array. As an example, this number may be multiple garbage collection cycles or may be one garbage collection cycle, depending on the particular embodiment of the invention. In response to determining that the predetermined number of cycle or cycles has occurred, the memory manager 34 enlarges the size of the part one data region 64 based on the heap availability. Thus, if after a particular garbage cycle or number of garbage cycles has occurred, a larger memory segment is available for the part one data region 64, the memory manager 34 may add more contiguous memory to the region 64.

As another example, the memory manager 34 may perform a technique 310 in response to one or more predetermined number of garbage collection cycles (diamond 34) occurring. In determination that such a number of garbage collection cycles has occurred, the memory manager 34 reallocates (block 314) the sizes of the allocated segments for the array. For example, the garbage collector 34 may observe that a particular tailing part of the array is accessed more frequently than the part one data region 64. In this case, in some embodiments of the invention, the memory manager 34 may enlarge this particular trailing part by allocating more contiguous memory to the trailing part that has become available due to the garbage collection cycle. Other variations are possible, in other embodiments of the invention.

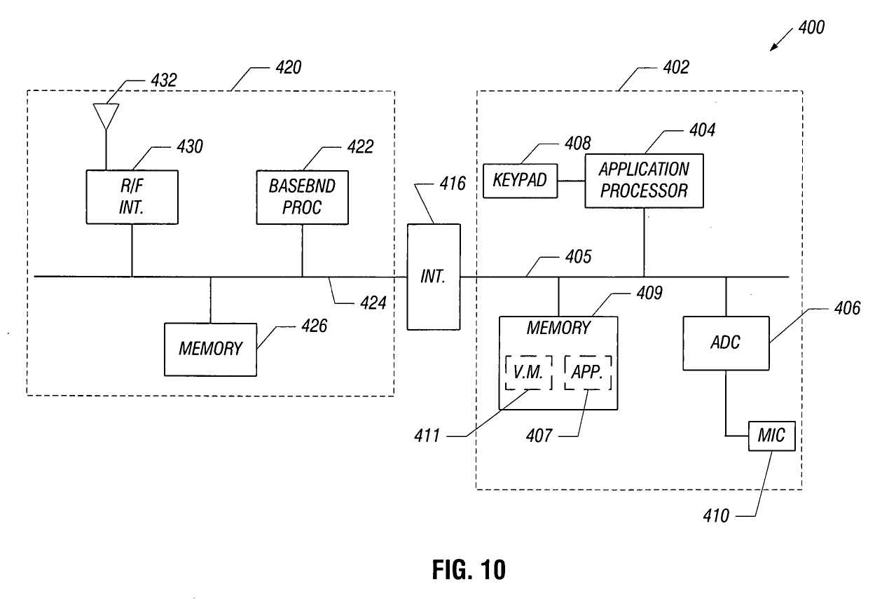

Referring to FIG. 10, in some embodiments of the invention, the above-described memory manager may be used in a system that has a limited memory capacity, such as a wireless device 400. This wireless device may be, for example, a cellular telephone, a pager, a personal digital assistant (PDA), etc. The system 400 includes an application subsystem 402 and a baseband system 420. The application subsystem 402 controls the user interface of the wireless device 400 as well as executing various application programs (applets, for example) that may be loaded onto and stored on the wireless device 400.

The application subsystem 402 includes an application processor 404 that may access a memory 409 of the subsystem 402 via a bus 405. The memory 409 may store, for example, instructions 411 for establishing a virtual machine that includes a memory manager, such as the memory manager 34. Thus, via execution of the instructions 411, the application processor 404 may create the memory manager 34 that performs the memory management techniques described herein. Furthermore, the memory 409 may include instructions 407 for several applet or other application programs. These programs may be, for example, applets that create objects that allocate arrays that are handled by the object manager of the virtual machine, for example. Among its other features, the application subsystem 402 may include an analog-to-digital converter (ADC) 406 that receives analog inputs such as from a microphone 410, for example. The application processor 404 may also receive input from a keypad 408.

The application subsystem 402 communicates with the baseband system 420 via an interface 416. The baseband subsystem 420 may include a baseband processor 422 for establishing, for example, one of many possible communication protocols, such as communication protocol with a cellular network, for example. The baseband processor 422 communicates with a memory 426 via a bus 424. The memory 426 may store programs directing operation of the baseband processor 422, as well as storing configuration information for the subsystem 420. The baseband subsystem 420 may also include a radio frequency (R/F) interface 430 that is coupled to the bus 424. The interface 430, in turn, is coupled to an antenna (a dipole antenna, for example) that receives and transmits RF signals for the wireless system 400.

The wireless device 400 is one out of many possible embodiments of a system that may use the memory management techniques described herein. Therefore, other embodiments are within the scope of the appended claims.

While the invention has been disclosed with respect to a limited number of embodiments, those skilled in the art, having the benefit of this disclosure, will appreciate numerous modifications and variations therefrom. It is intended that the appended claims cover all such modifications and variations as fall within the true spirit and scope of the invention.

What is claimed is:

1. A method comprising:
assigning a first pointer to an address of an array;
using the first pointer to identify a first location of first data of the array; and
using the first pointer to locate at least one additional pointer to identify at least one additional location of additional data of the array.

2. The method of claim 1, further comprising:
finding an available contiguous memory segment larger than substantially all other available contiguous memory segments of a memory; and
using the found available contiguous memory segment to store the first data.

3. The method of claim 2, wherein the first pointer identifies a location of the available memory segment.

4. The method of claim 2, wherein finding comprises finding an available contiguous memory segment that has the maximum size of all other available contiguous segments of the memory.

5. The method of claim 1, further comprising:
using the first pointer to identify an array reference that includes the first data and said at least one additional pointer.

6. The method of claim 1, further comprising:
using the first pointer to identify an array reference that includes header information identifying an site that created the array.

7. The method of claim 1, further comprising:
using the first pointer to identify an array reference that includes information identifying a size of the first data.

8. The method of claim 1, further comprising:
using the first pointer to identify an array reference that includes information that identifies a size of the array.

9. The method of claim 1, further comprising:
using the first pointer to identify an array reference that includes information that identifies a first size of the first data and a second size of the array, wherein the first size is not equal to the second size.

10. The method of claim 1, wherein first data is part of a contiguous memory region that includes said at least one additional pointer and the first data.

11. The method of claim 10, wherein additional data is not part of the contiguous region.

12. The method of claim 11, wherein additional data comprises data segments that span across a plurality of non-contiguous memory regions.

13. The method of claim 1, further comprising:
changing a size of the first data in response to the occurrence of at least one memory reallocation cycle.

14. The method of claim 1, further comprising:
changing the first location in response to the occurrence of at least one memory reallocation cycle.

15. An article comprising a computer readable storage medium storing instructions to cause a processor-based system to:
assign a first pointer to an address of an array;
use the first pointer to identify a first location of first data of the array; and
use the first pointer to locate at least one additional pointer to identify at least one additional location of additional data of the array.

16. The article of claim 15, the storage medium storing instructions to cause the processor to find an available contiguous memory segment larger than substantially all other available contiguous memory segments and use the found available contiguous memory segment to store the first data.

17. The article of claim 16, wherein the first pointer identifies a location of the available contiguous memory segment.

18. The article of claim 16, the storage medium storing instructions to cause the processor-based system to find an available contiguous memory segment that has a maximum compared to all other available contiguous memory segments.

19. The article of claim 15, the storage medium storing instructions to cause the processor-based system to use the first pointer to identify an array reference that includes information that identifies a first size of the first data and a second size of the array, wherein the first size is not equal to the second size.

20. The article of claim 15, wherein the first data is part of a contiguous memory region that includes said at least one additional pointer and the first data.

21. A system comprising:
a processor; and
a memory to cause the processor to
assign a first pointer to an address of an array,
use the first pointer to identify a first location of first data of the array, and
use the first pointer to locate at least one additional pointer to identify at least one additional location of additional data of the array.

22. The system of claim 21, the processor to find an available contiguous memory segment larger than substantially all other available contiguous memory segments of a memory and use the found available contiguous memory segment to store the first data.

23. The system of claim 22, wherein the first pointer identifies a location of the available memory segment.

24. The system of claim 21, wherein the first data is part of a contiguous memory region that includes said at least one additional pointer in the first data.

25. The system of claim 24, wherein the additional data comprises data segments that span across a plurality of non-contiguous memory regions.

26. A system comprising:
a wireless interface;
a processor; and
a memory to cause the processor to
assign a first pointer to an address of an array,
use the first pointer to identify a first location of first data of the array, and
use the first pointer to locate at least one additional pointer to identify at least one additional location of additional data of the array.

27. The system of claim 26, the processor to find an available contiguous memory segment larger than substantially all other available contiguous memory segments and use the available contiguous memory segment to store the first data.

28. The system of claim 27, wherein the first pointer identifies a location of the available contiguous memory segment.

29. The system of claim 26, wherein the first data is part of a contiguous memory region that includes said at least one additional pointer in the first data.

30. The system of claim 29, wherein the additional data comprises data segments that span across a plurality of non-contiguous memory regions.
